(19) United States
(12) Patent Application Publication
(10) Pub. No.: US 2024/0155413 A1
(43) Pub. Date: May 9, 2024

(54) CONFIGURATION AND USE OF INTERMEDIATE NETWORKS TO SUPPORT WIRELESS COMMUNICATIONS

(71) Applicant: Charter Communications Operating, LLC, St. Louis, MO (US)

(72) Inventors: Christopher D. Burke, Parker, CO (US); Christopher J. Teague, Castle Pines, CO (US)

(21) Appl. No.: 17/980,121

(22) Filed: Nov. 3, 2022

(51) Int. Cl. H04W 28/02; H04L 47/2491; H04W 40/12

(52) U.S. Cl. CPC H04W 28/0268; H04L 47/2491; H04W 40/12

(57) ABSTRACT

An example communication system includes a communication management resource to control conveyance of data associated with a wireless communication link over a network path. The communication management resource receives a notification of a mobile communication device requesting to establish wireless connectivity with a wireless base station. The notification may indicate a type of communications to be supported by the wireless connectivity. In response to the notification, the communication management resource selects first data flow control settings based on the indicated type of communications associated with the wireless connectivity. The communication management resource then implements the first data flow control settings in a network path between the wireless base station and the remote network to support the type of communications indicated by the notification.

### BACKGROUND

Conventional wireless networks typically include one or more wireless base stations or wireless base stations to provide mobile communication devices (a.k.a., user equipment) access to a remote network such as the Internet or other target communication devices. In certain instances, the wireless networks include many different types of networks and/or components that must collectively work together to provide wireless services.

One conventional type of wireless network is a 5G wireless network. A 5G wireless network typically includes at least one so-called 5G radio access networks (RANs) and corresponding 5G core network. A conventional 5G wireless base station may be connected to a 5G core network via an IP network commonly referred to as a backhaul. 5G networks implement dynamic policy to enforce behaviors on user traffic.

### BRIEF DESCRIPTION OF EMBODIMENTS

This disclosure include includes the observation that conventional backhauls are deficient in supporting connectivity between conventional 5G wireless base stations and 5G core network. For example, embodiments herein include novel ways of providing better wireless service via configuring and subsequent use of an intermediate network between a wireless base station and a remote network.

More specifically, an example communication system as discussed herein includes a communication management resource (such as a single centrally located resource or multiple distributed resources working collectively) to control conveyance of data associated with a wireless communication link over a network path. The communication management resource receives a notification of a mobile communication device requesting to establish wireless connectivity with a wireless base station. The notification may indicate a type of communications (such as voice communications, nonvoice communications, video, etc.) to be supported by the wireless connectivity. In response to the notification, the communication management resource selects first data flow control settings based on the indicated type of communications associated with the wireless connectivity. The communication management resource then implements the first data flow control settings (pertinent to the type of data associated with the wireless communication link) in a network path between the wireless base station and the remote network to support the type of communications indicated by the notification.

In one example, selection of the first data flow control settings includes: mapping the indicated type of communications to be supported by the requested wireless communication link to a particular quality of service required for the wireless connectivity; and configuring one or more of the network path and the wireless connectivity to support the particular quality of service for the type of communications indicated by the notification.

Further embodiments herein include, via the communication management resource, maintaining map information mapping multiple different wireless communication link types to corresponding multiple different instances of data flow control settings applicable to the network path for the different wireless link types. The map information can be configured to map a first wireless communication link type to the first data flow control settings and a second wireless communication link type to second data flow control settings. Assume that the type of communications as indicated by the notification correspond to the first wireless communication link type. In such an instance, the communication management resource selects the data flow control settings via mapping the type of communications as specified by the notification to the first data flow control settings.

In still further example embodiments, the communication management resource generates wireless link settings to establish the wireless connectivity. The wireless link settings support the type of communications and corresponding quality of service as specified by the notification. The communication management resource can be configured to communicate the wireless link settings to the wireless base station. In such an instance, the implementation of the wireless link settings by the wireless base station support the wireless connectivity between the mobile communication device and the wireless base station in accordance with the type of wireless communications as specified by the notification.

Via the first data flow control settings, the communication management resource: establishes a data flow in the network path between the wireless base station and a network node providing access to the remote network. For example, the communication management resource can be configured to establish a secured tunnel over the network path via the data flow between the network node and the wireless base station. A combination of i) the established wireless connectivity between the wireless base station and the mobile communication device, and ii) the secured tunnel between the wireless base station and the network node convey uplink and downlink communications between the mobile communication device and the remote network in accordance with a quality of service assigned to the type of communications as specified by the notification.

Still further example embodiments herein include, via the determined first data flow control settings to support the requested wireless communication link, configuring at least a portion of the network path between the wireless base station and a network node to support a quality of service assigned to the type of communications as specified by the notification, the network node being a gateway to the remote network. Via a secured tunnel established in the network path between the wireless base station (a.k.a., wireless access point) and the network node, the communication management resource and corresponding intermediate network such as the network path control conveyance of uplink communications and downlink communications between the wireless base station and the remote network in accordance with a quality of service corresponding to the type of wireless communications as specified by the notification.

Controlled conveyance of the uplink communications and the downlink communications through the intermediate network (network path such as including secured tunnel) may include: receiving first data at the network node from the remote network, the first data destined for delivery to the mobile communication device; generating a data packet to include the first data and a first quality of service code, the first quality of service code assigned to provide the quality of service corresponding to the type of communications as specified by the requested wireless communication link as indicated by the notification; and communicating the generated data packet over the secured tunnel, the secured tunnel (intermediate network) forwarding the generated data packet in accordance with the first quality of service code. Still further, the wireless base station may retrieve the first data from the generated data packet and forward the first data over the wireless connectivity to the mobile communication device.

In still further example embodiments, implementation of the first data flow control settings includes the communication management resource applying the first data flow control settings to a cable modem and a cable modem termination system in the network path to convey data associated with the communications in accordance with a quality of service assigned to the type of communications to be supported by the wireless communication link as specified by the notification.

In yet further example embodiments, implementation of the first data flow control settings includes the communication management resource applying the first data flow control settings to multiple routers (such as in a backhaul or intermediate network) in the network path to convey data associated with the communications in accordance with a quality of service assigned to the type of communications as specified by the notification.

Embodiments herein are useful over conventional techniques. For example, control of data flows over a wireless link and a corresponding network path (such as intermediate network) as discussed herein provides improved data delivery services to mobile communication devices.

Note that any of the resources as discussed herein can include one or more computerized devices, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, firmware, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by computer processor hardware, cause the computer processor hardware (such as one or more co-located or disparately processor devices or hardware) to: receive a notification of a mobile communication device requesting to establish wireless connectivity with a wireless base station, the notification indicating a type of communications to be supported by the wireless connectivity; in response to the notification, select first data flow control settings amongst multiple possible data flow control settings based on the indicated type of communications associated with the wireless connectivity; and implement the selected first data flow control settings in a network path between the wireless base station and the remote network to support the type of communications indicated by the notification.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless services to communication devices. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a communication management resource configuring and controlling data flows over a wired communication link (such as intermediate network) and wireless communication link for a first mobile communication device as discussed herein.

FIG. 2 is an example diagram illustrating implementation of wireless connectivity settings and flow control settings supporting uplink communications as discussed herein.

FIG. 3 is an example diagram illustrating implementation of wireless connectivity settings and flow control settings to supporting downlink communications as discussed herein.

FIG. 4 is an example diagram illustrating a communication management resource configuring and controlling data flows over one or more wired or wireless communication links for a second mobile communication device as discussed herein.

FIG. 5 is an example diagram illustrating implementation of wireless connectivity settings and flow control settings supporting uplink communications associated with the second mobile communication device as discussed herein.

FIG. 6 is an example diagram illustrating implementation of wireless connectivity settings and flow control settings to supporting downlink communications associated with the second mobile communication device as discussed herein.

FIG. 7 is an example diagram illustrating configuration of routers in a backhaul (intermediate network) to support data flows as discussed herein.

FIGS. 8 and 9 are example diagrams illustrating registration and implementation of data flow control settings in an intermediate network as discussed herein.

FIG. 10 is an example diagram illustrating control of data flows in a downlink direction from a remote network through an intermediate network to a mobile communication device as discussed herein.

FIG. 11 is an example diagram illustrating control of data flows in an uplink direction from a remote network through an intermediate network to a mobile communication device as discussed herein.

FIG. 12 is an example diagram illustrating configuration of routers and other resources in a backhaul to support data flows as discussed herein.

FIGS. 13 and 14 are example diagrams illustrating registration and implementation of data flow control settings in an intermediate network as discussed herein.

FIG. 15 is an example diagram illustrating control of data flows in a downlink direction from a remote network through an intermediate network to a mobile communication device as discussed herein.

FIG. 16 is an example diagram illustrating control of data flows in an uplink direction from a remote network through an intermediate network to a mobile communication device as discussed herein.

FIG. 17 is an example diagram illustrating example computer architecture operable to execute one or more operations as discussed herein.

FIG. 18 is an example diagram illustrating a method as discussed herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

According to one configuration, an example communication system includes a communication management resource to control conveyance of data associated with a wireless communication link over a network path (such as intermediate network). The communication management resource receives a notification of a mobile communication device requesting to establish wireless connectivity with a wireless base station. The notification may indicate a type of communications to be supported by the wireless connectivity. In response to the notification, the communication management resource selects first data flow control settings based on the indicated type of communications associated with the wireless connectivity. The communication management resource then implements the first data flow control settings in the network path between the wireless base station and the remote network to support the type of communications indicated by the notification.

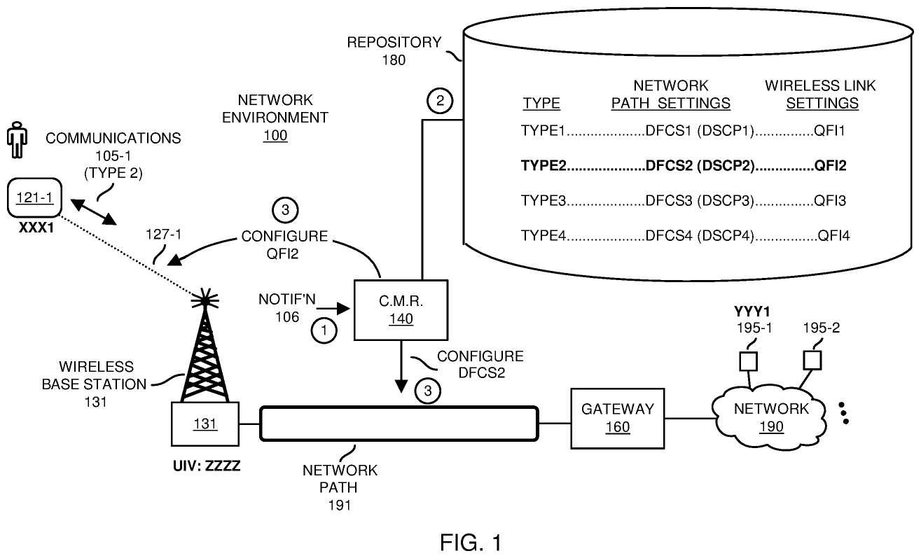

Now, more specifically, FIG. 1 is an example diagram illustrating a communication management resource configuring and controlling data flows over one or more wired and/or wireless communication links for a first mobile communication device as discussed herein.

As shown, network environment 100 includes mobile communication device 121-1, wireless base station 131, communication management resource 140, repository 180, network path 191, gateway 160, network 190, and corresponding communication devices 195 (communication device 195-1, communication device 195-2, etc.).

In this example, each of the resources such as wireless base station 131, gateway 160, communication devices 195, etc., operate as a communication management resource to support connectivity of the mobile communication device 121-1 to one or more resources in network 190.

Note that the network path 191 (such as disposed in an intermediate network between the wireless base station 131 and the gateway 160 (includes any number of different communication resources (routers, hardwired communication links, processing circuitry, etc.) to convey communications between the wireless base station 131 and the gateway 160.

Note that any of the resources as described herein include hardware or software resources (or a combination of both) in which to carry out respective operations. For example, communication management resource 140 can be configured as communication management hardware, communication management software, or a combination of communication management hardware and communication management software;

mobile communication device 121-1 can be configured as communication management hardware, communication management software, or a combination of communication management hardware and communication management software; wireless base station 131 can be configured as communication management hardware, communication management software, or a combination of communication management hardware and communication management software; gateway 160 can be configured as communication management hardware, communication management software, or a combination of communication management hardware and communication management software; communication device 195-1 can be configured as communication management hardware, communication management software, or a combination of communication management hardware and communication management software; and so on.

As discussed herein, the communication management resource 140 controls a configuration of the multiple resources such as mobile communication device 121-1, wireless base station 131, network path 191, and gateway 160 to support conveyance of data between the mobile communication device 121-1 and the one or more communication devices 195.

More specifically, in processing operation #1,assume that the communication management resource 140 receives a notification of a mobile communication device 121-1 requesting to establish wireless connectivity 127-1 with the wireless base station 131. The notification indicates a type of communications 105-1 (type 2) to be supported by the wireless connectivity 127-1.

In processing operation #2, in response to the notification 106, the communication management resource 140 selects data flow control settings (DFCS2 and QFI2) to apply to the network path 191 (such as including one or more of wireless link, hardware link, routers, switches, repeaters, driver, hardwire cables, etc.) and the wireless communication link 127-1 based on the indicated type of communications (type 2) associated with the wireless connectivity 127-1. In this example, the type 2 communications 105-1 associated with the requested wireless communication link 127-1 require a certain quality of service (such as latency threshold, bandwidth threshold, etc.) through the corresponding intermediate network including network path 191 between the wireless base station 131 and the gateway 160.

As further discussed herein, to support the type 2 communications 105-1 with remote network 190, the communication management resource 140 configures the mobile communication device 121-1 and the wireless base station 131 to support wireless link settings QFI2; the communication management resource 140 configures the wireless base station 131 and gateway 162 support network path settings DFCS2 (such as including a corresponding marker DSCP2 to support communications over the network path 191).

In processing operation #3, the communication management resource 140 implements first wireless link settings QFI1 over the wireless connectivity 127-1 between the wireless base station 131 and the mobile communication device 121-1. Further in processing operation #3, the communication management resource 140 implements the first data flow control settings DFCS2 (and DSCP2) in the network path 191 between the wireless base station 131 and the remote network 190 to support the type 2 communications indicated by the notification 106.

In one embodiment, the combination of network path settings DFCS2 (DSCP2 in an intermediate network between the wireless base station 131 and the gateway 160) and wireless link settings QFI2 (applied to wireless communication link 127-1 and the network 190) provide an appropriate bandwidth and ensure conveyance of communications that a sufficiently high priority such that the latency of such communications is below a latency threshold value such as through network path 191 and/or between the mobile communication device 105-1 and a destination communication device 195-1 in the remote network 190.

Subsequent to configuration, the resources as discussed herein provide the quality of service in accordance with the network path settings DFCS2 and wireless link settings QFI2 for the communications 105-1 associated with wireless communication link 127-1.

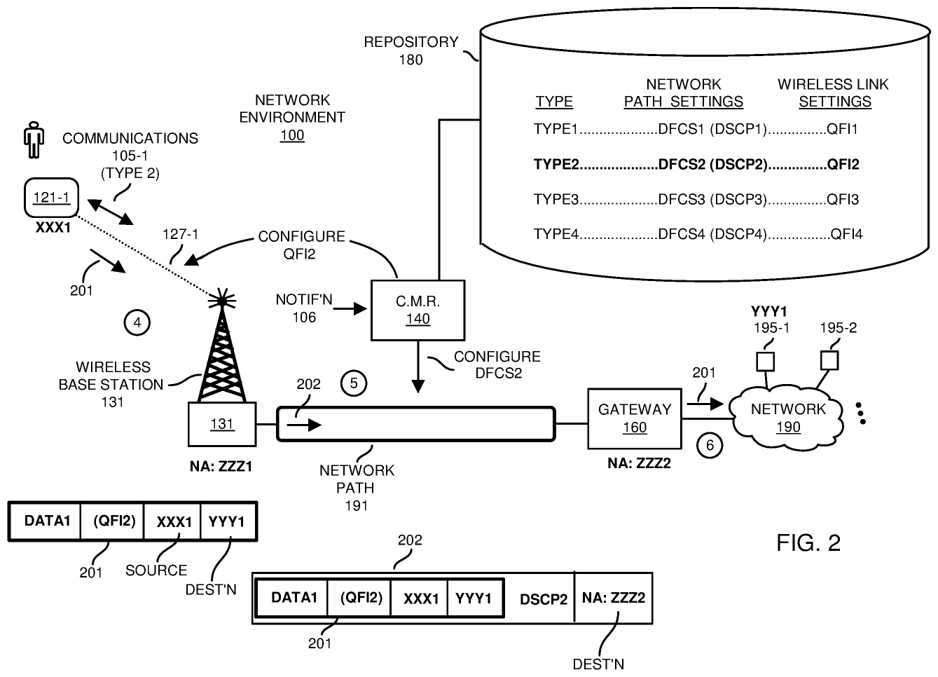

FIG. 2 is an example diagram illustrating implementation of wireless connectivity settings and flow control setting to support uplink communications as discussed herein.

Subsequent to configuration as previously discussed, assume that the mobile communication device 121-1 (having an assigned network address of XXX1) generates corresponding DATA1 for transmission to a target destination such as communication device 195-1 (having assigned network address of YYY1) via communications 105-1. In such an instance, the mobile communication device 121-1 generates the communications 201 (such as data packet) to include DATA1 as well as a corresponding source address of XXX1 of the mobile communication device 121-1 and destination address of YYY1 of the communication device 195-1. The mobile communication device 121-1 can be configured to generate the communication 201 to include the marker QFI2 indicating to one or more other resources in the network that the corresponding communication 201 is to be afforded the quality of service assigned to the type 2 communications 105-1.

As further shown, the mobile communication device 121-1 wirelessly communicates the communications 201 over the wireless communication link 127-1 to the wireless base station 131. In accordance with the prior configuration using network path settings DFCS2, the wireless base station 131 encapsulates the received communication 201 to produce communication 202 with a destination of network address ZZZ2 assigned to the gateway 160. In this example, the wireless base station 131 includes the marker DPCS2 to indicate a corresponding quality of service to be provided to the communication 202 as it is transmitted through the network path 191 (such as including a secure tunnel) from the wireless base station 131 to the gateway 160.

Yet further, the gateway 160 receives the communication 202 over the network path 191. Prior to forwarding the corresponding DATA1 and corresponding data packet, the gateway 160 processes the communication 201 to retrieve the original communication 201. Based on a destination address YYY1 of the corresponding communication 201, the gateway 106 forwards the communication 201 to the communication device 195-1 and network 190. The network 190 can be configured to forward the communication 201 in accordance with the quality of service associated with the marker QFI2.

In this manner, the configuration of the wireless communication link 127-1 via the wireless link settings QFI2 and configuration of the network path 191 (such as intermediate network) with the network path settings DFCS2 ensures that the end-to-end communications of DATA1 between the mobile communication device 121-1 and the resource 195-1 is provided the appropriate quality of service for the type 2 communications (such as voice communications between the mobile communication device 121-1 and a destination device 195-1).

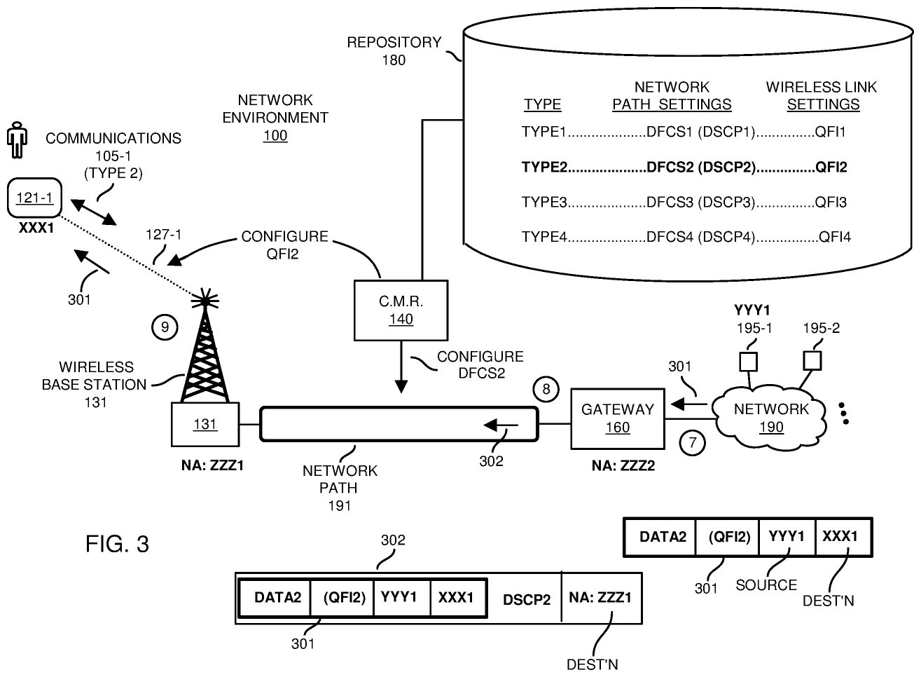

FIG. 3 is an example diagram illustrating implementation of wireless connectivity settings and flow control setting to support downlink communications as discussed herein.

Subsequent to configuration, assume that the communication device 195-1 (having an assigned network address of YYY1) generates corresponding DATA2 for transmission to a target destination such as communication device 121-1 (having assigned network address of XXX1) via communications 105-1. In such an instance, the communication device 195-1 generates the communications 301 (such as data packet) to include DATA2 as well as a corresponding source address of YYY1 and destination address of XXX1. The communication 301 may include the marker QFI2 indicating to one or more other resources in the network that the corresponding communication 301 is to be afforded a quality of service delivery assigned to the type 2 communications 105-1.

As further shown, the mobile communication device 195-1 communicates the communications 301 over the network 190 to the gateway 160. In accordance with the prior configuration using network path settings DFCS2 (marker DSCP2), the gateway 160 encapsulates the received communication 301 to produce communication 302 including network address ZZZ1 assigned to the wireless base station 131. In this example, the gateway 160 includes the marker DSCP2 in the communication 302 to indicate a corresponding quality of service to be provided to the communication 302 as it is transmitted over the network path 191 (such as intermediate network including a secure tunnel) from the gateway 160 to the wireless base station 131. The network path 191 forwards the communication 302 in accordance with the quality of service afforded DSCP2 to the wireless base station 131 as indicated by the destination network address ZZZ1 in the communication 302.

Yet further, the wireless base station 131 receives the communication 302 over network path 191. Prior to forwarding the corresponding DATA2, the gateway 160 processes the communication 302 to retrieve the original communication 201. Based on a destination address XXX1 of the corresponding communication 301, the wireless base station 131 wirelessly communicates the communications 301 over wireless communication link 127-1 to the mobile communication device 121-1.

In this manner, the configuration of the wireless communication link 127-1 via the wireless link settings QFI2 and configuration of the network path 191 to support the network path settings DFCS2 ensures that the end-to-end communications of DATA2 communicated from the communication device 195-1 to the mobile communication device 121-1 is provided the appropriate quality of service for the type 2 communications (such as voice communications between the communication device 195-1 and the mobile communication device 121-1).

As further discussed below, the network path 191 and wireless services provided by the wireless base station 131 support different qualities of service depending upon the type of communications to be supported.

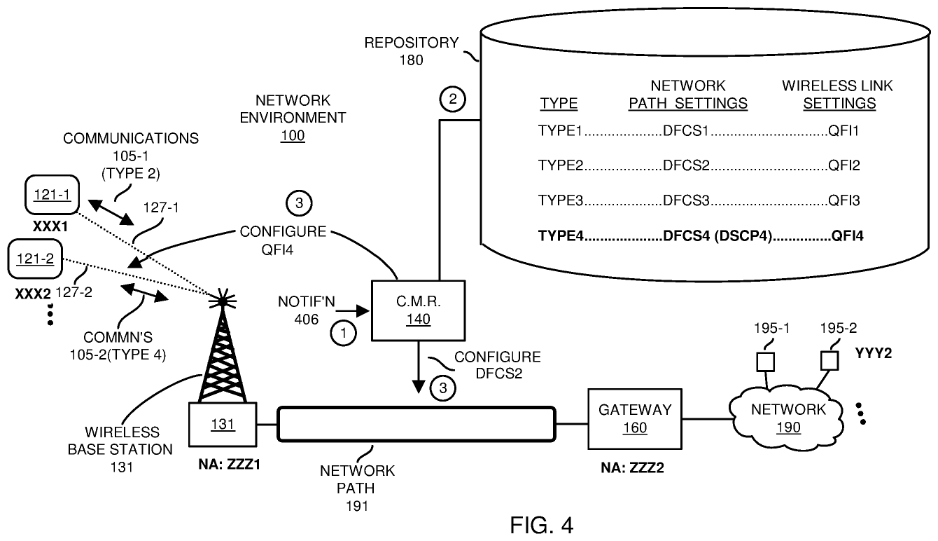

FIG. 4 is an example diagram illustrating a communication management resource configuring and controlling data flows over one or more of a wired and wireless communication link for a second mobile communication device as discussed herein.

More specifically with reference to FIG. 4, in processing operation #1, the communication management resource 140 receives a notification 406 of a mobile communication device 121-2 requesting to establish wireless connectivity 127-2 with the wireless base station 131. The notification indicates a type of communications 105-2 (type 4) to be supported by the wireless connectivity 127-2.

In processing operation #2, in response to the notification 406, the communication management resource 140 selects data flow control settings (DFCS4 and QFI4) to apply to the network path 191 and the wireless communication link 127-4 to support the indicated type of communications (type 4) associated with the wireless connectivity 127-4. In this example, the type 4 communications 105-2 require a corresponding quality of service (such as latency threshold, bandwidth threshold, etc.). To support the type 4 communications with remote network 190, the communication management resource 140 configures the mobile communication device 121-2 and the wireless base station 131 to support wireless link settings QFI4; the communication management resource 140 configures the wireless base station 131 and gateway 160 to support network path settings DFCS4.

In processing operation #3, the communication management resource 140 implements first wireless link settings QFI4 over the wireless connectivity 127-2 between the wireless base station 131 and the mobile communication device 121-2 for the communications 105-2. Further in processing operation #3, the communication management resource 140 implements the data flow control settings DFCS4 (using marker DSCP4) in the network path 191 between the wireless base station 131 and the remote network 190 to support the type 4 communications 105-2 indicated by the notification 406.

Subsequent to configuration, the resources as discussed herein provide the quality of service in accordance with the network path settings DFCS4 (using data forwarding marker DSCP4) and wireless link settings QFI4 for the communications 105-2 associated with wireless communication link 127-2.

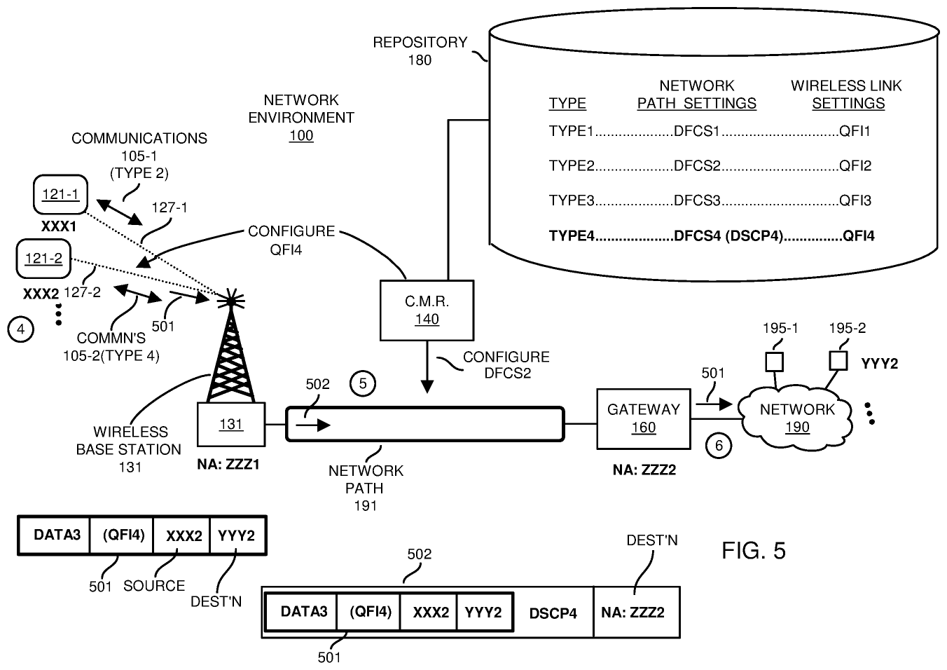

FIG. 5 is an example diagram illustrating implementation of wireless connectivity settings and flow control setting to support uplink communications as discussed herein.

Subsequent to configuration, assume that the mobile communication device 121-2 (having an assigned network address of XXX2) generates corresponding DATA3 for transmission via communications 105-2 to a target destination such as communication device 195-2 (having assigned network address of YYY2). In such an instance, the mobile communication device 105-2 generates the communications 501 (such as data packet) to include DATA3 as well as a corresponding source address of XXX2 and destination address of YYY2. The communication 501 may include the marker QFI4 indicating to one or more other resources in the network that the corresponding communication 501 is to be afforded a quality of service assigned to the type 4 communications 105-2.

As further shown, the mobile communication device 121-2 wirelessly communicates the communications 501 over the wireless communication link 127-2 to the wireless base station 131. In accordance with the prior configuration using network path settings DFCS4 (and assigned marker DSCP4), the wireless base station 131 encapsulates the received communication 501 to produce communication 502 include destination network address ZZZ2 for routing same. In this example, the wireless base station 131 includes the marker DCSP4 in the communication 502 to indicate a corresponding quality of service to be provided to the communication 502 as it is transmitted through the network path 191 (such as intermediate network including a secure tunnel) from the wireless base station 131 to the destination network address ZZZ2 (i.e., gateway 160).

Yet further, the gateway 160 receives the communication 502 over the network path 191. Prior to forwarding the corresponding DATA3 or packet, the gateway 160 processes the communication 502 to retrieve the original communication 501. Based on a destination address YYY2 of the corresponding communication 501, the gateway 106 forwards the communication 501 over network 190 in accordance with the quality of service as specified by or assigned to QFI4 to the communication device 195-2.

In this manner, the configuration of the wireless communication link 127-2 via the wireless link settings QFI4 and configuration of the network path 191 with the network path settings DFCS4 ensures that the end-to-end communications of DATA3 between the mobile communication device 121-2 and the resource 195-2 is provided the appropriate quality of service for the type 4 communications (such as voice communications between the mobile communication device 121-2 and a destination device 195-2).

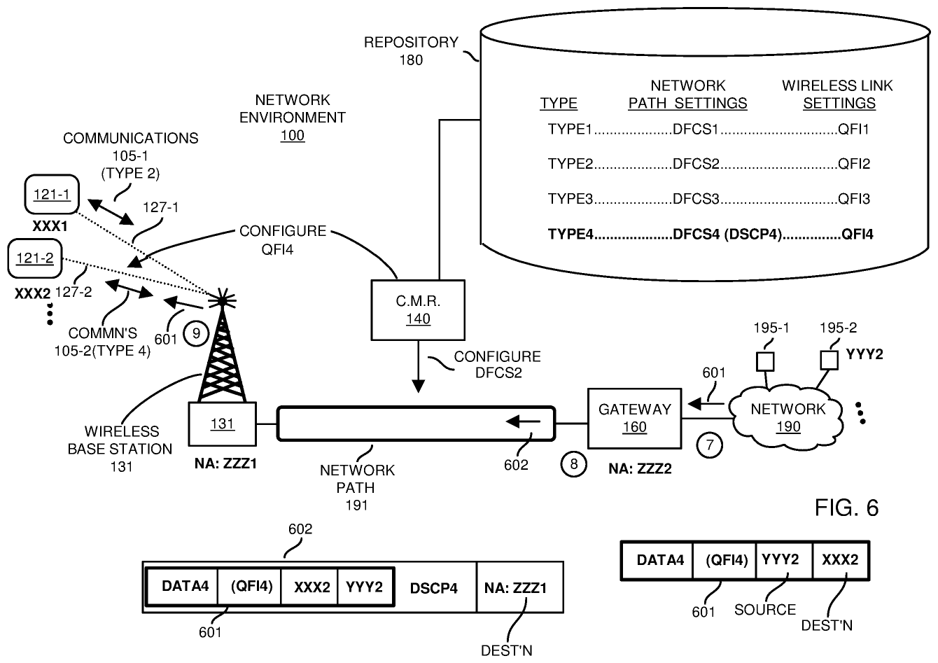

FIG. 6 is an example diagram illustrating implementation of wireless connectivity settings and flow control setting to support downlink communications as discussed herein.

Subsequent to configuration, assume that the communication device 195-2 (having an assigned network address of YYY2) generates corresponding DATA4 for transmission to a target destination such as communication device 121-2 (having assigned network address of XXX2) via communications 105-2. In such an instance, the communication device 195-2 generates the communications 601 (such as data packet) to include DATA4 as well as a corresponding source address of YYY2 and destination address of XXX2. The communication 601 may include the marker QFI4 indicating to one or more other resources in the network that the corresponding communication 601 is to be afforded a quality of service assigned to the type 4 communications 105-2.

As further shown, in accordance with the quality of service afforded to QFI4, the communication device 195-2 and corresponding remote network 190 communicate the communications 601 to the gateway 160. In accordance with the prior configuration using network path settings DFCS4 for communications to the mobile communication device 121-2 or wireless base station 131, the gateway 160 encapsulates the received communication 601 to produce communication 602 including a destination network address of ZZZ1. In this example, the gateway 160 includes the marker DCSP4 associated with network path settings DFCS4 in the communication 602 to indicate a corresponding quality of service to be provided to the communication 602 as it is transmitted over the network path 191 (such as including a secure tunnel) from the gateway 160 to the wireless base station 131 assigned network address ZZZ1.

Yet further, the wireless base station 131 receives the communication 602 over network path 191. Prior to forwarding the corresponding DATA4 or corresponding communication 601, the gateway 160 processes the communication 602 to retrieve the original communication 601. Based on a destination address XXX2 of the corresponding communication 601 associated with communication 601, the wireless base station 131 wirelessly communicates the communications 601 over wireless communication link 127-1 to the mobile communication device 121-2 in accordance with the quality of service associated with QFI4.

In this manner, the configuration of the wireless communication link 127-2 via the wireless link settings QFI4 and configuration of the network path 191 with the network path settings DFCS4 for communications 105-2 associated with the wireless communication link 127-2 ensures that the end-to-end communications of DATA4 communicated from the communication device 195-2 to the mobile communication device 121-2 is provided the appropriate quality of service for the type 4 communications 105-2 (such as non-voice communications between the communication device 195-2 and the mobile communication device 121-2).

Thus, the network path 191 and wireless services provided by the wireless base station 131 support different qualities of service depending upon the type of communications to be conveyed.

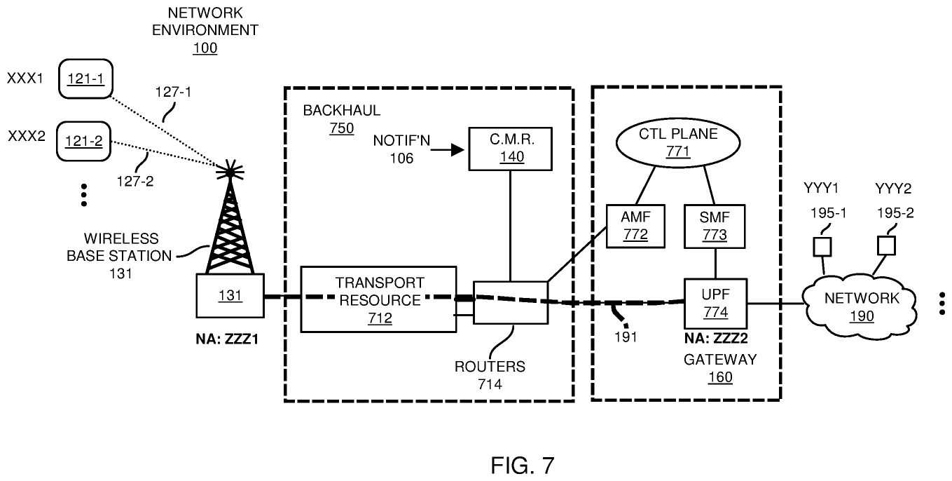

FIG. 7 is an example diagram illustrating configuration of routers in a backhaul to support data flows as discussed herein.

As shown, this example of network environment 100 includes mobile communication device 121-1, mobile communication device 121-2, wireless base station 131, backhaul 750, gateway 160, network 190, and communication devices 195 (such as communication device 195-1 and communication device 195-2).

In this example, the backhaul 750 supporting network path 191 includes communication management resource 140, transport resource 712, and routers 714. The combination of the transport resource 712 and the routers 714 provide support for the network path 191 and corresponding conveyance of communications over the network path 191.

As previously discussed, the communication management resource 140 can be configured to configure the network path 191 and corresponding resources such as transport resource 712, switches, routers 714, etc., to support conveyance of respective data associated with the wireless connectivity 127.

As further shown, the gateway 160 includes control plane 171 (such as a communication management resource or network supporting control plane functions), AMF 172 (such as a communication management resource supporting an access and mobility management function), SMF 173 (such as a communication management resource supporting a session management function), and UPF 174 (such as a communication management resource supporting a user plane function).

One terminal end of the network path 191 is connected to the UPF 774 of the gateway 160. Another terminal end of the network path 191 is connected to the wireless base station 131. As previously discussed, the network path 190 can be configured to support a secured tunnel for each data flow associated with mobile communication devices.

The wireless communication link 127-1 and wirelessly communication link 127-2 can be configured to support wireless communications and/or wireless connectivity in accordance with any suitable wireless communication protocol. In one embodiment, the wireless communication links 127 support 5G communications.

In this example, each of the resources such as wireless base station 131, network path 191, transport resource 712, routers 714, gateway 160, communication devices 195, etc., operates as a communication management resource to support connectivity of the mobile communication device 121-1 to one or more resources in network 190.

Note that the network path 191 includes any number of different communication resources (routers, hardwired communication links, processing circuitry, etc.) to convey communications between the wireless base station 131 and the gateway 160.

Note that any of the resources as described herein include hardware or software resources (or a combination of both) in which to carry out respective operations. For example, the control plane 171 can be configured as corresponding communication management hardware, communication management software, or a combination of communication management hardware and communication management software; the AMF 172 can be configured as corresponding communication management hardware, communication management software, or a combination of communication management hardware and communication management software; the SMF 173 can be configured as communication management hardware, communication management software, or a combination of communication management hardware and communication management software; the UPF 174 can be configured as communication management hardware, communication management software, or a combination of communication management hardware and communication management software; gateway 160 can be configured as communication management hardware, communication management software, or a combination of communication management hardware and communication management software; and so on.

In a similar manner as previously discussed, the communication management resource 140 controls a configuration of the multiple resources such as mobile communication device 121-1, wireless base station 131, network path 191, gateway 160, etc., to support conveyance of data between the mobile communication device 121-1 and the one or more communication devices 195.

In one embodiment, 5G control plane traffic and/or user plane traffic traverse a backhaul 750. The backhaul 750 may include IP connectivity between a 5G wireless base station 131 and a 5G core network (such as remote network 190). The solution as described herein includes creating a backhaul slice manager (such as communication management resource 140), which interacts with the 5G core network control plane (771). From a 5G standpoint, the backhaul slice manager would be considered an application function (a.k.a., AF) and may connect directly to the 5G control plane or indirectly through a network exposure function (a.k.a., NEF). One attribute of the backhaul slice manager (such as communication management resource 140) would be to determine information about the wireless base station 131 (a.k.a., gNB), AMF, and the UPF; including but not limited to, IP address of the endpoints, configure network slices, DNSs, traffic volumes, etc. Using network identities, the routers 714 in the backhaul 750 apply the appropriate modifications to the routers 714 to enable better enforcement of the traffic from communication device 121-1 to communication device 195-1.

As an example use case, a private 5G network (such as wireless base station 131) may be deployed in a warehouse with 5G connected automated machinery (such as communication devices 121). The workers have 5G general-purpose devices (such as mobile communication devices 121) and 5G augmented reality glasses to be used in the warehouse floor. The 5G network may be set up with 3 network slices—one serving machinery, one serving general-purpose devices, and one serving augmented reality devices; respectively. The backhaul slice manager can be configured to gain information about each network slice, the performance requirements of each, and which wireless base stations and UPS to serve each slice. The backhaul slice management can be configured to optimize the configurations of the routers in the backhaul 750 to serve each slice and provide different levels of service to each slice.

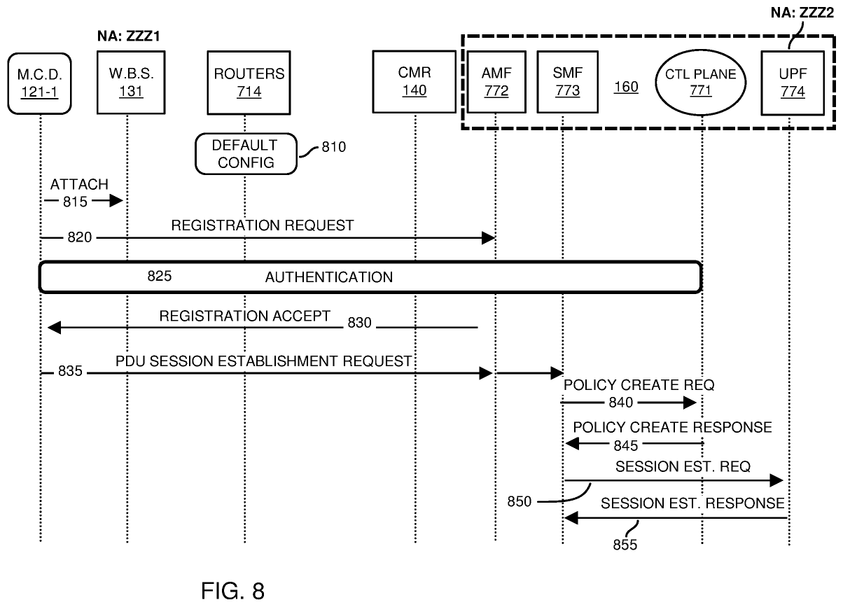

FIG. 8 is an example diagram illustrating registration and implementation of data flow control as discussed herein.

In this example, in processing operation 810, the communication management resource 140 configures the routers 714 with a default configuration in which the wireless base station 131 is able to communicate with the gateway 160 and vice versa via the default network configuration.

Via communications 815, the wireless base station 131 receives a request from the mobile communication device 121-1 to establish a respective wireless communication link 127-1.

Via communications 820, the mobile communication device 121-1 communicates a respective registration request to the AMF 772. The request specifies a particular type of communication link such as a type 2 link supporting communications 105-1.

In response to receiving the registration request, the control plane 771 performs authentication of the mobile communication device 121-1 to use the requested service via communications 825.

Via communications 830, the AMF 772 provides notification of the registration acceptance indicating that the mobile communication device 121-1 and/or corresponding user operating the mobile communication device 121-1 have been authenticated to use the requested wireless services provided by the wireless base station 131. In response to the registration accept message, the mobile communication device 121-1 and the wireless base station 131 then establish the wireless communication link 127-1.

Via communications 835, the mobile communication device 121-1 communicates a respective PDU session establishment request to the AMF 772. In one embodiment, the communications 820 or the communications 835 indicate that the mobile communication device 121-1 would like to establish the wireless communication link 127-1 to support type 2 communications 105-1 (such as voice communications or phone call). The AMF 772 provides notification of the PDU session establishment request to the SMF 773. In response to receiving the request, the SMF 773 proceeds with creating an appropriate policy (then as data flow control settings) in the control plane 771 to support the type 2 communications 105-1 (such as voice communications).

Via communications 840, the SMF 773 communicates a policy create request message to the control plane 771 to create a respective policy to support the type 2 communications 105-1.

Via communications 845, the control plane 771 communicates a policy create response to the SMF 773. In one embodiment, the policy create response in communications 845 includes settings (such as data flow control settings or policy information) for supporting the data flows (associated with the wireless communication link 127-1) in the control plane 771.

Via communications 850, the SMF 773 communicates a session establishment request to the UPF 774. The communications 850 can include settings to set up a data flow in or associated with the control plane. The UPF 774 sets up a respective requested session using the received data flow control settings such as information indicating data flow types, end points of a tunnel, corresponding IP addresses of one or more device/resource, bandwidth supported, etc.

Via communications 855, the UPF 774 provides a session establish response notification indicating that the data flows have been established for the session. For example, data flows associated with the mobile communication device 121-1 are assigned DSCP2 and QFI2.

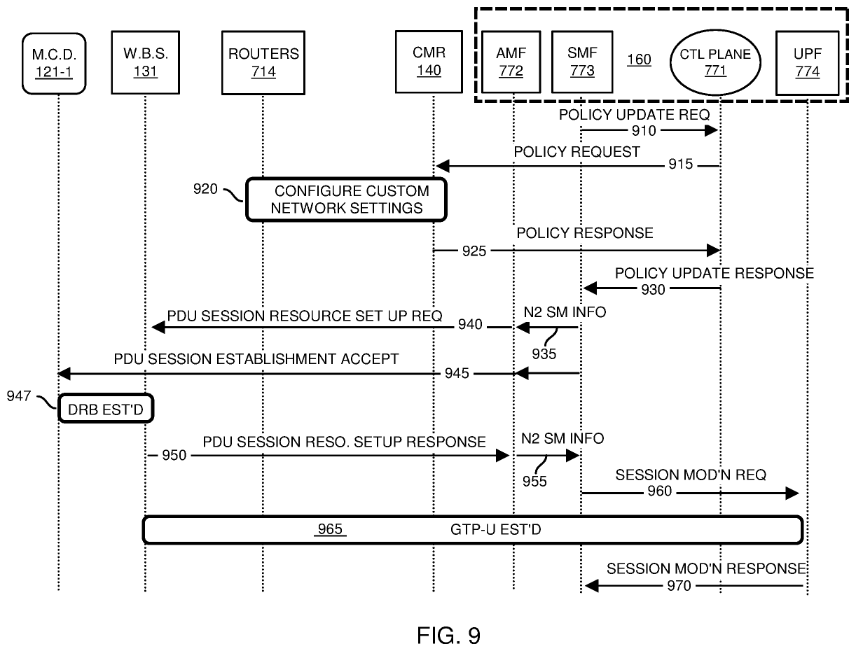

FIG. 9 is an example diagram illustrating registration and implementation of data flow control as discussed herein.

As further shown in FIG. 9, via communications 910, the SMF 773 communicates a policy update request to the control plane 771. Communications 910 can include final information about setting up the respective communication session to support data associated with the type 2 communications 105-1.

Via communications 915, the control plane 771 communicates a message to the communication management resource 140 to implement custom network settings in the backhaul 750 (routers 714) to support the type 2 communications 105-1 associated with the requested session. The communications 950 may include the custom network settings in which to apply to the routers 714. Via processing operation 920, the communication management resource 140, as previously discussed, sets or configures up the routers 714 to support the type 2 communications 105-1 associated with the wireless communication link 127-1.

Via communications 925, the communication management resource 125 communicates a policy response message to the control plane manager 771 indicating that the backhaul 715 and corresponding routers 714 have been properly set up to support the type 2 communications 105-1 associated with the wireless communication link 127-1.

Via communications 930, the control plane 771 communicates a policy update response message to the SMF 773, the response indicating that the backhaul 750 and corresponding resources have been configured to support the type 2 communications 105-1.

Via communications 935, the SMF 773 communicates an N2 SM information message to the AMF 772.

Via communication 940, the AMF 772 communicates a PDU session resource set up request to the wireless base station 131. In one embodiment, the request includes appropriate configuration setting information for application use by the wireless base station 131 to support the type 2 communications 105-1 over the backhaul 750.

Via communications 945, the AMF 772 communicates a PDU session establishment accept message to the mobile communication device 121-1. In one embodiment, the message includes appropriate configuration setting information for use by the mobile communication device 121-1 to support the type 2 communications 105-1 over the backhaul 750.

In processing operation 947, DRB (Data Radio Bearer) is established between the mobile communication device 121-1 and the wireless base station 131 to support the wireless communication link 127-1. In one example embodiment, the DRB defines the packet treatment of communicating the communications 105-1 over the wireless communication link 127-1.

Via communications 950, the wireless base station 131 communicates a PDU session resource set up response message to the AMF 772 indicating set up of the DRB. Via communications 955, the AMF 772 sends a corresponding N2 SM information message to the SMF 773.

Via communications 960, the SMF 773 provides notification of the session modification request to the UPF 774. In processing operation 965, the network path 191 is established between wireless base station 131 and the UPF 774 to support secure communications associated with the wireless communication link 127-1.

Via communications 970, the UPF 774 communicates a session modification response 970 to the SMF 773 indicating the established network path 191.

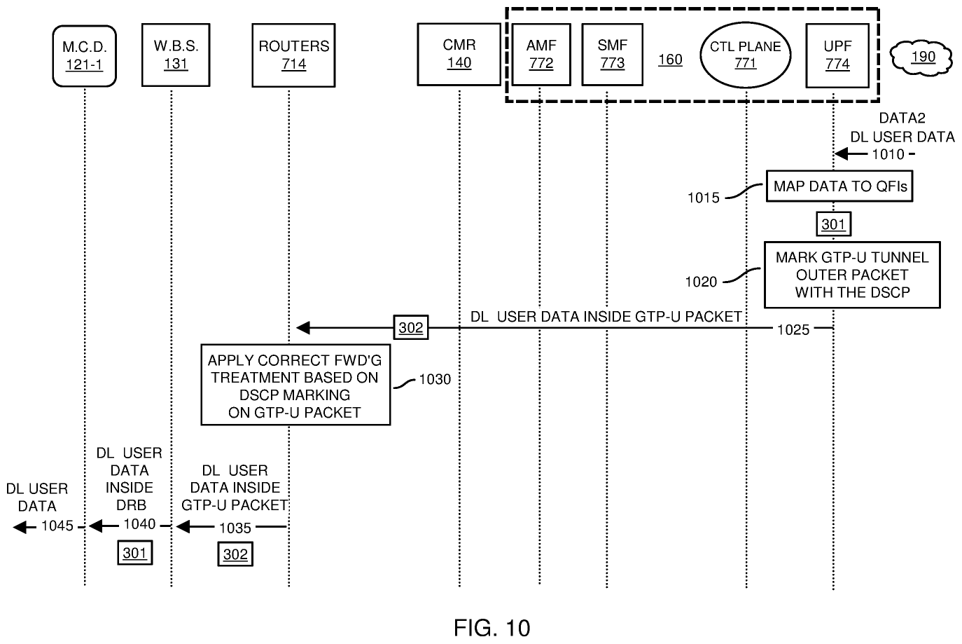

FIG. 10 is an example diagram illustrating control of data flows in a downlink direction from a remote network to a mobile communication device as discussed herein.

Subsequent to setting up the network path 191 (via configuration of corresponding wireless base station 131, routers 714, transport resource 712, etc.) to support the type 2 wireless communications 105-1, the network supports downlink communications from the remote network 190 to the mobile communication device 121-1.

For example, the UPF 774 receives data (such as DATA2) in communications 1010 for delivery to the mobile communication device 121-1.

In response to receiving the DATA2, the UPF 774 maps the data and corresponding identifier YYY1 of the target mobile communication device 121-1 associated with DATA2 to an appropriate delivery service code such as QFI2 supporting the type 2 communications 105-1.

In processing operation 1020, the UPF 774 creates a respective communication 302 in which to communicate over the network path 191. In one embodiment, the communication 302 includes network address ZZZ1 (wireless base station 131) as a destination and is marked with a delivery service code DSCP2 (associated with QFI2). Via communications 1025, the UPF 774 forwards the communication 302 to the routers 714.

In processing operation 1030, the routers 714 determine forwarding treatment of the received communication 302 based upon the delivery service code DSCP2 included in the communication 302. In other words, the routers 714 use the code DSCP2 in the communication 302 to determine and implement forwarding requirements to wireless base station 131.

Via communications 1035, the routers 714 forward the communications 302 to the destination wireless base station 131 (ZZZ1).

The wireless base station 131 retrieves the communication 301 from the received communication 302 and forwards the communication 301 as communications 1040 over the wireless communication link 127-1 to the mobile communication device 121-1 in accordance with the quality of service as specified by the service code QFI2.

In processing operation 1045, the mobile communication device 121-1 retrieves the DATA2 from the communication 301 and provides it to an appropriate target application in the mobile communication device 121-1 to which the DATA2 pertains.

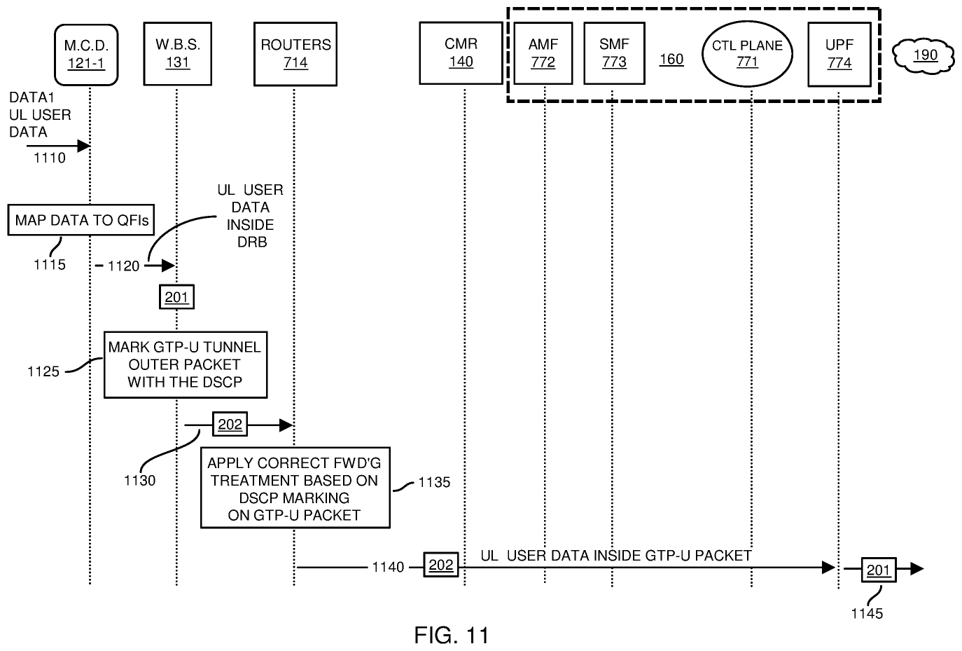

FIG. 11 is an example diagram illustrating control of data flows in an uplink direction from a remote network to a mobile communication device as discussed herein. Subsequent to setting up the network path 191 (via configuration of corresponding routers 714 and transport resource 712) to support the type 2 wireless communications 105-1, the network supports uplink communications from the mobile communication device 121-1 to the remote network 190.

For example, the mobile communication device 121-1 receives data (such as DATA1) in communications 1110 for delivery to a target communication device such as the communication device 195-1.

In response to receiving the DATA1 (which pertains to an application generating communications 105-1), in processing operation 1115, the mobile communication device 121-1 maps the received data to an appropriate delivery service code such as QFI2 supporting the type 2 communications 105-1 and creates communication 201 to convey the DATA1.

In processing operation 1120, the mobile communication device 121-1 wirelessly communicates the communication 201 over wireless communication link 127-1 to the wireless base station 131. As previously discussed, the communication 201 includes DATA1.

In processing operation 1125, the wireless base station 131 creates a respective communication 202 in which to communicate over the network path 191 and destination 195-1 through UPF 774. The communication 202 may be an encapsulation of communication 201 including destination network address ZZZ2. In one embodiment, the wireless base station 131 marks the communication 202 with a delivery service code DSCP2 (associated with QFI2).

Via communications 1130, the wireless base station 131 forwards the communication 202 to the routers 714 for delivery to a destination communication device 195-1.

In processing operation 1135, the routers 714 determine forwarding treatment to apply to the received communication 202 based upon the delivery service code DSCP2 included in the communication 202.

Via communications 1140, the routers 714 forward the communication 202 to the UPF 774 (network address ZZZ2) in accordance with a quality of service associated with the marker DSCP2.

The UPF 774 retrieves the communication 201 from the received communication 202 and forwards the communication 201 as communications 1145 over the network 190 to the appropriate destination YYY1 in accordance with a quality of service as specified by the service code QFI2.

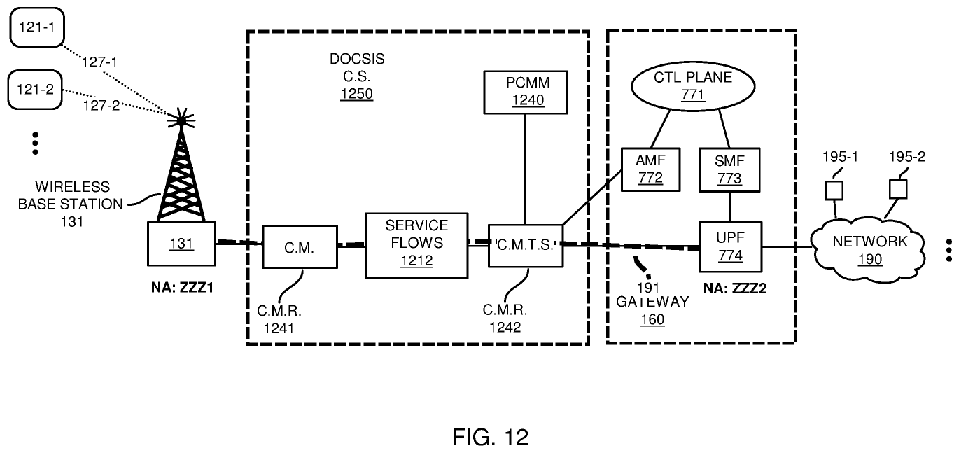

FIG. 12 is an example diagram illustrating configuration of routers in a cable modem system to support data flows as discussed herein.

As shown, this example of network environment 100 includes mobile communication device 121-1, mobile communication device 121-2, wireless base station 131, DOCSIS communication system 1250, gateway 160, network 190, and communication devices 195 (such as communication device 195-1 and communication device 195-2).

The DOCSIS communication system 1250 supports network path 191, which includes communication management resource 1241 (such as a cable modem) service flows 1212, communication management resource 142 (such as a cable modem termination system). The combination of the communication management resource 141, service flows 1212, and communication management resource 142 provide support for the network path 191 (such as a secured communication link or tunnel) and corresponding conveyance of communications over the network path 191. As previously discussed, the communication management resource 140 can be configured to configure the network path 191 and corresponding resources such as communication management resource 1241, service flows 1212, and communication management resource 1242, etc., to support conveyance of respective data associated with the wireless connectivity 127. As further shown, the gateway 160 includes control plane manager 171, AMF 172 (such as a communication management resource supporting an access and mobility management function), SMF 173 (such as a communication management resource supporting a session management function), and UPF 174 (such as a communication management resource supporting a user plane function). One terminal end of the network path 191 is connected to the UPF 174 of the gateway 160. Another terminal end of the network path 191 is connected to the wireless base station 131. As previously discussed, the network path 190 supports a secured wireless tunnel for each data flow associated with mobile communication devices.

The wireless communication link 127-1 and wirelessly communication link 127-2 can be configured to support wireless communications and/or wireless connectivity in accordance with any suitable wireless communication protocol. In one embodiment, the wireless communication links 127 support 5G communications.

In this example, each of the resources such as wireless base station 131, network path 191, communication management resource 1241, service flows 1212, communication management resource 1242, gateway 160, communication devices 195, etc., operates as a communication management resource to support connectivity of the mobile communication device 121-1 to one or more resources in network 190.

Note that the network path 191 includes any number of different communication resources (routers, hardwired communication links, processing circuitry, etc.) to convey communications between the wireless base station 131 and the gateway 160.

In a similar manner as previously discussed, the communication management resource PCMM 1240 controls a configuration of the multiple resources such as mobile communication device 121-1, wireless base station 131, network path 191, gateway 160, etc., to support conveyance of data between the mobile communication device 121-1 and the one or more communication devices 195.

In one implementation, a 5G control plane traffic and user plane traffic traverse a DOCSIS communication system 1250 (intermediate network) between a 5G wireless base station (such as wireless base station 131) and a corresponding 5G core network (gateway 160). A packet cable multimedia (such as PCMM 1240) can be used as a policy server for the DOCSIS communication system. One solution is described herein includes modifying or configuring the PCMM to interact with the cable modem termination system (CMTS) and the DOCSIS communication system 1250 to interact with the 5G core network control plane. From a 5G standpoint, the PCMM 1240 would be considered an application function (AF) and may connect directly to the 5G control plane or indirectly through a network exposure function (NEF). One purpose of the PCMM 1240 may be to gain knowledge from the 5G core network (such as gateway 160) about the wireless base station 131, AMF, and UPF; including, but not limited to, IP address of the endpoints, configured network slices, DNNs, traffic volumes, etc. Using this information, the PCMM 1240 (communication management resource) can be configured to create traffic profiles (data flow control settings) for the different types of traffic traversing the DOCSIS communication system 1250, identify the cable modem termination system serving this traffic, and apply the appropriate modifications to the CMTS resources (such as communication management resource 1241 and communication management resource 1242) to enable better enforcement of the traffic from a mobile communication device 121-1 to a destination communication device 195-1.

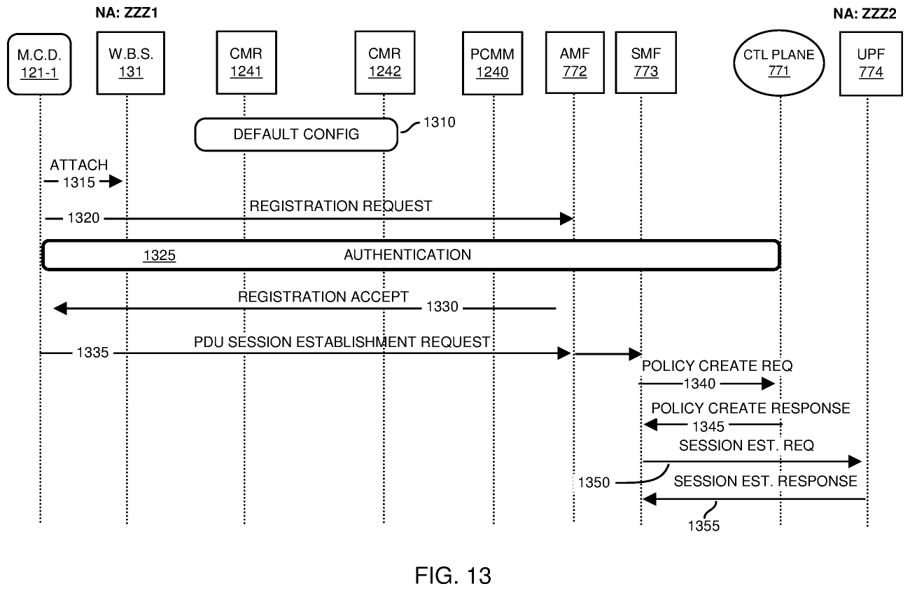

FIG. 13 is an example diagram illustrating registration and implementation of data flow control as discussed herein.

In this example, in processing operation 1310, the PCMM 1240 or other suitable entity configures the communication management resource 1241, service flows 1212, and communication management resource 1242, etc., with a default configuration in which the wireless base station 131 is able to communicate with the gateway 160 and vice versa.

Via communications 1315, the wireless base station 131 receives a request from the mobile communication device 121-1 to establish a respective wireless communication link 127-1.

Via communications 1320, the mobile communication device 121-1 communicates a respective registration request to the AMF 772. The request specifies a particular type of communication link or data type such as a type 2 link supporting communications 105-1.

In response to receiving the registration request, the control plane 771 performs authentication of the mobile communication device 121-1 to use the requested wireless service via communications 1325.

Via communications 1330, the AMF 772 provides notification of the registration acceptance indicating that the mobile communication device 121-1 and/or corresponding user have been authenticated to use the requested wireless services provided by the wireless base station 131. In response to the registration accept message, the mobile communication device 121-1 and the wireless base station 131 then establish the wireless communication link 127-1.

Via communications 1335, the mobile communication device 121-1 communicates a respective PDU session establishment request to the AMF 772. In one embodiment, the communications 1320 or the communications 1335 indicate that the mobile communication device 121-1 would like to establish the wireless communication link 127-1 to support type 2 communications 105-1 (such as voice communications or phone call requiring a certain quality of service supported by QFI2 and DSCP2). The AMF 772 provides notification of the PDU session establishment request to the SMF 773. In response to receiving the request, the SMS 773 proceeds with establishing an appropriate policy (i.e., data flow control settings) in the control plane 771 to support the type 2 communications 105-1 (such as voice communications).

Via communications 1340, the SMF 773 communicates a policy request message to the control plane 771 to create a respective policy to support the type 2 communications 105-1.

Via communications 1345, the control plane 771 communicates a policy create response to the SMF 773. In one embodiment, the policy create response in communications 1345 includes settings (such as data flow control settings or policy information) for supporting the data flows in the control plane 771.

Via communications 1350, the SMF 773 receives a session establishment request from the SMF 773. The communications 850 can include settings to set up a data flow in the control plane. The UPF 774 sets up a respective requested session using the received data flow control settings such as information indicating data flow types, end points of a tunnel associated with network path 191, corresponding IP addresses of one or more device/resource, bandwidth supported by the data flows, etc.

Via communications 1355, the UPF 774 provides a session established response notification indicating that the data flows have been established for the session (i.e., communications 105-1).

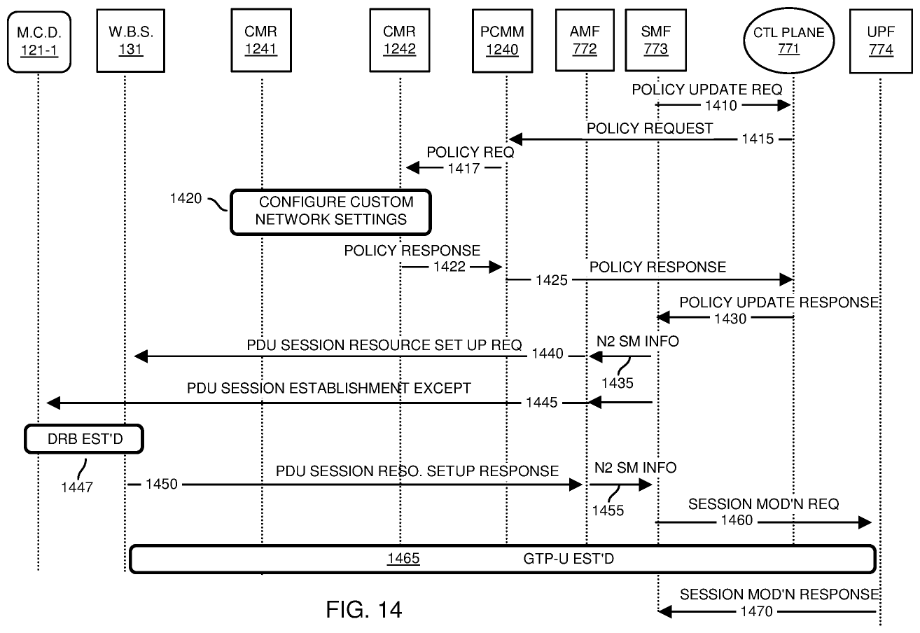

FIG. 14 is an example diagram illustrating registration and implementation of data flow control as discussed herein.

As further shown in FIG. 14, via communications 1410, the SMF 773 communicates a policy update request to the control plane 771. Communications 1410 can include final information about setting up the respective communication session in network path 191 to support data associated with the type 2 communications 105-1.

Via communications 1415, the control plane 771 communicates a message to the PCMM 1240 to implement custom network settings in the DOCSIS system 1250 to support the type 2 communications 105-1 associated with the requested session. The communications 1415 may include the custom network settings in which to apply to the communication management resources 1241 and 1242 or other resources associated with network path 191. The PCMM 1240 forwards the policy request and configuration setting information to the communication management resources 1241 and 1242. Via processing operation 1420, the communication management resources 1241 and 1242 establish the network path 191 to support the type 2 communications 105-1 associated with the wireless communication link 127-1.

Via communications 1422, the communication management resource 1242 communicates a policy response to the PCMM 1240 indicating that the network path 191 and corresponding communication management resources 1241 and 1242 have been configured.

Via communications 1425, the communication management resource 125 communicates a policy response message to the control plane manager 771 indicating that the network path and corresponding communication management resources have been properly set up to support the type 2 communications 105-1 associated with the wireless communication link 127-1.

Via communications 1430, the control plane 771 communicates a policy update response message to the SMF 773, the response indicating that the communication management resources and corresponding network path 191 have been configured to support the type 2 communications 105-1.

Via communications 1435, the SMF 773 communicates an N2 SM information message to the AMF 772.

Via communication 1440, the AMF 772 communicates a PDU session resource set up request to the wireless base station 131. In one embodiment, the request includes appropriate configuration setting information for application or use by the wireless base station 131 to support conveyance of the type 2 communications 105-1 over the DOCSIS communication system 1250.

Via communications 1445, the AMF 772 communicates a PDU session establishment accept message to the mobile communication device 121-1. In one embodiment, the message includes appropriate configuration setting information for use by the mobile communication device 121-1 to support the type 2 communications 105-1 over the backhaul 750.

In processing operation 1447, DRB (Data Radio Bearer) settings are implemented between the mobile communication device 121-1 and the wireless base station 131 to support the wireless communication link 127-1. In one example embodiment, the DRB defines the packet treatment (QFI2) of communicating the communications 105-1 over the wireless communication link 127-1.

Via communications 1450, the wireless base station 131 communicates a PDU session resource set up response message to the AMF 772 indicating set up of the DRB.

Via communications 1455, the AMF 772 sends a corresponding N2 SM information message to the SMF 773.

Via communications 1460, the SMF 773 provides notification of the session modification request to the UPF 774. In processing operation 1465, the network path 191 (such as a GTP-U link or tunnel) is established between wireless base station 131 and the UPF 774 to support secure communications associated with the wireless communication link 127-1.

Via communications 1470, the UPF 774 communicates a session modification response in communications 1470 to the SMF 773 indicating the established network path 191.

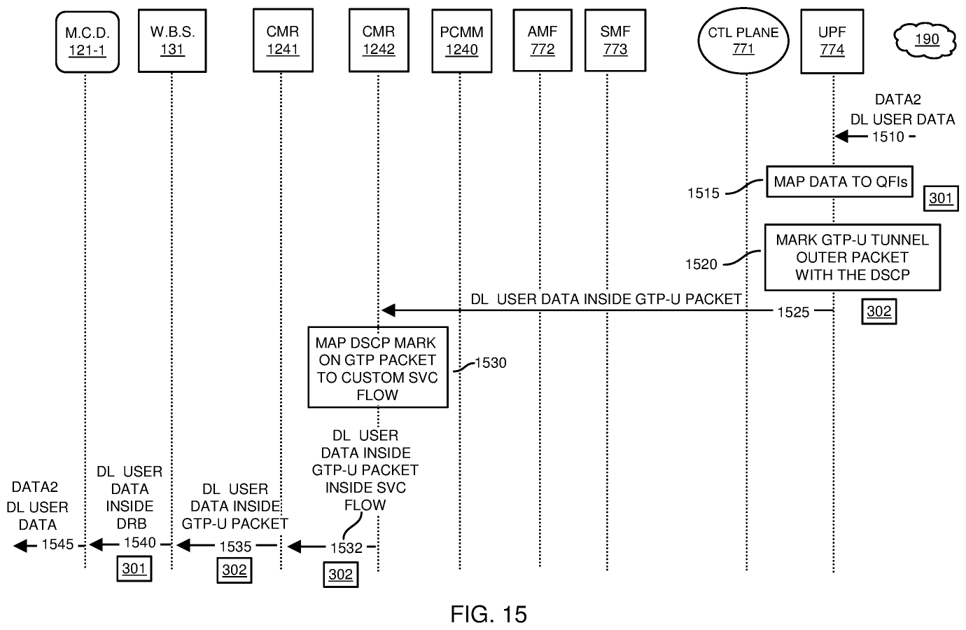

FIG. 15 is an example diagram illustrating control of data flows in a downlink direction from a remote network to a mobile communication device as discussed herein.

Subsequent to the PCMM 1240 or other suitable entity setting up the network path 191 (via configuration of corresponding wireless base station 131, communication management resources 1241 and 1242, etc.) to support the type 2 wireless communications 105-1, the intermediate network as discussed herein supports downlink communications from the remote network 190 to the mobile communication device 121-1.

For example, assume that the UPF 774 receives data (such as DATA2) in communications 1510 for delivery to the mobile communication device 121-1.

In response to receiving the DATA2, the UPF 774 maps the data and corresponding identifier XXX1 of the target mobile communication device 121-1 associated with DATA2 to an appropriate delivery service code such as QFI2 and/or DSCP2 supporting the type 2 communications 105-1.

In processing operation 1520, the UPF 774 creates a respective communication 302 (such as encapsulation of communication 301) in which to communicate over the network path 191. In one embodiment, the communication 302 is marked with a delivery service code DSCP2 (associated with QFI2).

Via communications 1525, the UPF 774 forwards the communication 302 to the communication management resource 1242 (such as a cable modem termination system).

In processing operation 1530, the communication management resource 1242 determines forwarding treatment of the received communication 302 based upon the delivery service code DSCP2 included in the communication 302. In other words, the communication management resource 1242 uses the delivery service code DSCP2 in the communication 302 to determine forwarding requirements and sends it (communications 302) over an appropriate data flow associated with the service code DSCP2 to communication management resource 1241 in communications 1532.

Via communications 1535, the communication management resource 1241 forwards the communication 302 to the wireless base station 131.

The wireless base station 131 retrieves the communication 301 from the received communication 302 and wirelessly forwards the communication 301 as communications 1040 over the wireless communication link 127-1 to the mobile communication device 121-1 in accordance with the quality of service as specified by the service code QFI2.

In processing operation 1545, the mobile communication device 121-1 retrieves the DATA2 from the communication 301 and provides it to an appropriate target application in the mobile communication device 121-1 to which the DATA2 pertains.

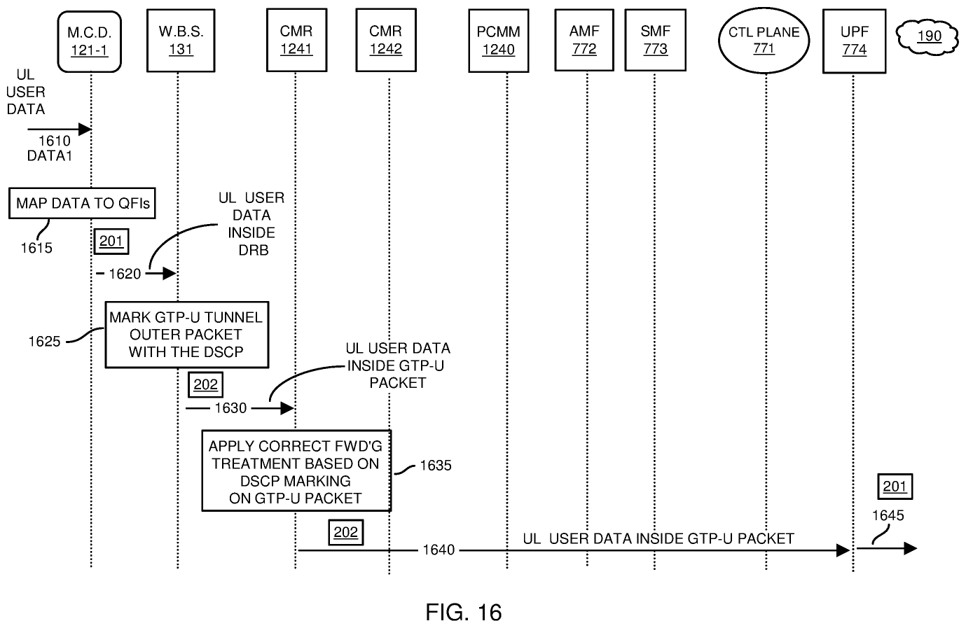

FIG. 16 is an example diagram illustrating control of data flows in an uplink direction from a remote network to a mobile communication device as discussed herein.

Subsequent to setting up the network path 191 (via configuration of corresponding resources) to support the type 2 wireless communications 105-1, the network supports uplink communications from the mobile communication device 121-1 to the remote network 190.

For example, assume that the mobile communication device 121-1 receives data (such as DATA1) in communications 1610 for delivery to a target communication device such as the communication device 195-1.

In response to receiving the DATA1 (which pertains to an application generating communications 105-1), in processing operation 1615, the mobile communication device 121-1 maps the received DATA1 to an appropriate delivery service code such as QFI2 supporting the type 2 communications 105-1 and creates communication 201 to convey the DATA1.

In processing operation 1620, the mobile communication device 121-1 wirelessly communicates the communication 201 over wireless communication link 127-1 to the wireless base station 131. As previously discussed, the communication 201 includes DATA1.

In processing operation 1625, the wireless base station 131 creates a respective communication 202 in which to communicate over the network path 191. The communication may be an encapsulation of communication 201. In one embodiment, the wireless base station 131 marks the communication 202 with a delivery service code DSCP2 (associated with QFI2).

Via communications 1630, the wireless base station 131 forwards the communication 202 to the communication management resource 1241 for delivery to a destination communication device.

In processing operation 1635, the communication management resource 1241 determines forwarding treatment to apply to the received communication 202 based upon the delivery service code DSCP2 included in the communication 202.

Via communications 1640, the communication management resource 1241 forwards the communication 202 to the UPF 774 (destination ZZZ2) in accordance with a quality of service associated with the marker DSCP2.

The UPF 774 retrieves the communication 201 from the received communication 202 and forwards the communication 201 as communications 1645 over the network 190 to the appropriate destination in accordance with a quality of service as specified by the service code QFI2.

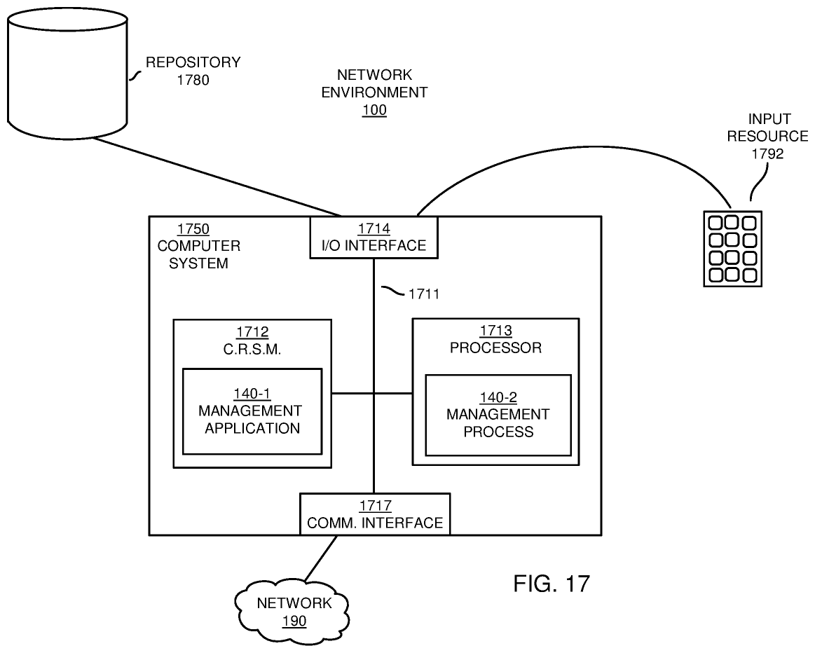

FIG. 17 is an example block diagram of a computer system for implementing any of the operations as previously discussed according to embodiments herein.

Any of the resources (such as communication management resource 140, mobile communication device 121-1, mobile communication device 121-2, wireless base station 131, communication management resource 1241, communication management resource 1242, router 714, AMF 772, the control plane 771, SMF 773, UPF 774, etc.) as discussed herein can be configured to include computer processor hardware and/or corresponding executable instructions to carry out the different operations as discussed herein.

As shown, computer system 1750 of the present example includes an interconnect 1711 coupling computer readable storage media 1712 such as a non-transitory type of media (which can be any suitable type of hardware storage medium in which digital information can be stored and retrieved), a processor 1713 (computer processor hardware), I/O interface 1714, and a communications interface 1717.

I/O interface(s) 1714 supports connectivity to repository 1780 and input resource 1792.

Computer readable storage medium 1712 can be any hardware storage device such as memory, optical storage, hard drive, floppy disk, etc. In one embodiment, the computer readable storage medium 1712 stores instructions and/or data.

As shown, computer readable storage media 1712 can be encoded with communication management application 140-1 (e.g., including instructions) to carry out any of the operations as discussed herein.

During operation of one embodiment, processor 1713 accesses computer readable storage media 1712 via the use of interconnect 1711 in order to launch, run, execute, interpret or otherwise perform the instructions in communication with bank letters the check. For the bank account management application 140-1 stored on computer readable storage medium 1712. Execution of the communication management application 140-1 produces communication management process 140-2 to carry out any of the operations and/or processes as discussed herein.

Those skilled in the art will understand that the computer system 1750 can include other processes and/or software and hardware components, such as an operating system that controls allocation and use of hardware resources to execute communication management application 140-1.

In accordance with different embodiments, note that computer system may reside in any of various types of devices, including, but not limited to, a mobile computer, a personal computer system, a wireless device, a wireless base station, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

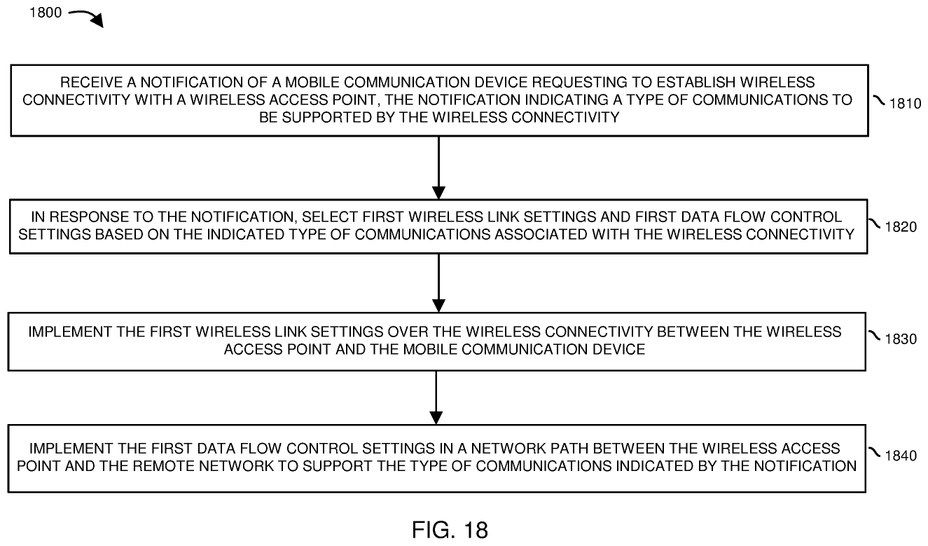

Functionality supported by the different resources will now be discussed via flowchart in FIG. 18. Note that the steps in the flowcharts below can be executed in any suitable order.

FIG. 18 is a flowchart 1800 illustrating an example method according to embodiments. Note that there will be some overlap with respect to concepts as discussed above.

In processing operation 1810, a communication management resource 140 receives a notification of a mobile communication device 121-1 requesting to establish wireless connectivity 127-1 with a wireless base station 131. The notification 106 indicates a type of communications (such as type 2) to be supported by the wireless connectivity 127-1.

In processing operation 1820, in response to the notification 106, the communication management resource 140 selects data flow control settings DFCS2 (such as service corresponding to DSCP2 and QFI2) based on the indicated type 2 of communications associated with the wireless connectivity 127-1.

In processing operation 1830, the communication management resource 140 implements wireless link settings QFI2 to communicate over the wireless communication link 127-1 between the wireless base station 131 and the mobile communication device 121-1.

In processing operation 1840, the communication management resource 140 implements the data flow control settings DFCS2 and marker DSCP2 (corresponding to service quality QFI2) in a network path 191 between the wireless base station 131 and the remote network 190 to support the type 2 communications 105-1 indicated by the notification 106.

Note again that techniques herein are well suited to facilitate controlled conveyance of data communications over a communication path. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving a notification of a mobile communication device requesting to establish wireless connectivity with a wireless base station, the notification indicating a type of communications to be supported by the wireless connectivity;
in response to the notification, selecting first data flow control settings based on the indicated type of communications associated with the wireless connectivity; and
implementing the first data flow control settings in a network path between the wireless base station and the remote network to support the type of communications indicated by the notification.

2. The method as in claim 1, wherein selecting the first data flow control settings includes: mapping the indicated type of communications to a particular quality of service to be supported by the wireless connectivity; and
wherein implementing the first data flow control settings in the network path includes: configuring the network path to support the particular quality of service for the type of communications indicated by the notification.

3. The method as in claim 1 further comprising:
maintaining a map mapping multiple different wireless communication link types to corresponding multiple different instances of data flow control settings applicable to the network path for the different wireless link types; and
wherein the map maps a first wireless communication link type to the first data flow control settings and a second wireless communication link type to second data flow control settings.

4. The method as in claim 3, wherein the type of communications as indicated by the notification corresponds to the first wireless communication link type; and
wherein selecting the data flow control settings includes: mapping the type of communications as specified by the notification to the first data flow control settings.

5. The method as in claim 1 further comprising:
generating wireless link settings to establish the wireless connectivity, the wireless link settings supporting the type of communications as specified by the notification; and
communicating the wireless link settings to the wireless base station, the wireless link settings supporting the wireless connectivity between the mobile communication device and the wireless base station in accordance with the type of wireless communications as specified by the notification.

6. The method as in claim 5 further comprising:
establishing a secured tunnel over the network path between the wireless base station and the network node.

7. The method as in claim 6, wherein a combination of i) the established wireless connectivity between the wireless base station and the mobile communication device, and ii) the secured tunnel between the wireless base station and the network node convey uplink and downlink communications between the mobile communication device and the remote network in accordance with a quality of service assigned to the type of communications as specified by the notification.

8. The method as in claim 1 further comprising:
via the first data flow control settings, configuring at least a portion of the network path between the wireless base station and a network node to support a quality of service assigned to the type of communications as specified by the notification, the network node being a gateway to the remote network.

9. The method as in claim 8 further comprising:
via a secured tunnel established in the network path between the wireless base station and the network node, controlling conveyance of uplink communications and downlink communications between the wireless base station and the remote network in accordance with a quality of service corresponding to the type of wireless communications as specified by the notification.

10. The method as in claim 9, wherein controlling conveyance of the uplink communications and the downlink communications includes:
receiving first data at the network node from the remote network, the first data destined for delivery to the mobile communication device;
generating a data packet to include the first data and a first quality of service delivery code, the first quality of service delivery code assigned to provide the quality of service corresponding to the type of communications as specified by the notification; and
communicating the generated data packet over the secured tunnel, the secured tunnel forwarding the generated data packet in accordance with the first quality of service code.

11. The method as in claim 10 further comprising:
at the wireless base station, retrieving the first data from the generated data packet; and
forwarding the first data over the wireless connectivity to the mobile communication device.

12. The method as in claim 1, wherein implementing the first data flow control settings includes: applying the first data flow control settings to a cable modem and a cable modem termination system in the network path to convey data associated with the communications in accordance with a quality of service assigned to the type of communications as specified by the notification.

13. The method as in claim 1, wherein implementing the first data flow control settings includes: applying the first data flow control settings to multiple routers in the network path to convey data associated with the communications in accordance with a quality of service assigned to the type of communications as specified by the notification.

14. A system comprising:
communication management hardware operative to:
receive a notification of a mobile communication device requesting to establish wireless connectivity with a wireless base station, the notification indicating a type of communications to be supported by the wireless connectivity;
in response to the notification, select first data flow control settings based on the indicated type of communications associated with the wireless connectivity; and
implement the first data flow control settings in a network path between the wireless base station and the remote network to support the type of communications indicated by the notification.

15. The system as in claim 14, wherein the communication management hardware is further operable to:
map the indicated type of communications to a particular quality of service to be supported by the wireless connectivity; and
configure the network path to support the particular quality of service for the type of communications indicated by the notification.

16. The system as in claim 14, wherein the communication management hardware is further operable to:
maintain a map mapping multiple different wireless communication link types to corresponding multiple different instances of data flow control settings applicable to the network path for the different wireless link types; and
wherein the map maps a first wireless communication link type to the first data flow control settings and a second wireless communication link type to second data flow control settings.

17. The system as in claim 16, wherein the type of communications as indicated by the notification corresponds to the first wireless communication link type; and
wherein the communication management hardware is further operable to: map the type of communications as specified by the notification to the first data flow control settings.

18. The system as in claim 14, wherein the communication management hardware is further operable to:
generate wireless link settings to establish the wireless connectivity, the wireless link settings supporting the type of communications as specified by the notification; and
communicate the wireless link settings to the wireless base station, the wireless link settings supporting the wireless connectivity between the mobile communication device and the wireless base station in accordance with the type of wireless communications as specified by the notification.

19. The system as in claim 18, wherein the communication management hardware is further operable to:
establish a secured tunnel over the network path between the network node and the wireless base station.

20. The system as in claim 19, wherein a combination of i) the established wireless connectivity between the wireless base station and the mobile communication device, and ii) the secured tunnel between the wireless base station and the network node convey uplink and downlink communications between the mobile communication device and the remote network in accordance with a quality of service assigned to the type of communications as specified by the notification.

21. The system as in claim 14, wherein the communication management hardware is further operable to:
via the first data flow control settings, configure at least a portion of the network path between the wireless base station and a network node to support a quality of service assigned to the type of communications as specified by the notification, the network node being a gateway to the remote network.

22. The system as in claim 21, wherein the communication management hardware is further operable to:
via a secured tunnel established in the network path between the wireless base station and the network node, control conveyance of uplink communications and downlink communications between the wireless base station and the remote network in accordance with a quality of service corresponding to the type of wireless communications as specified by the notification.

23. The system as in claim 22, wherein the communication management hardware is further operable to:
receive first data at the network node from the remote network, the first data destined for delivery to the mobile communication device;
generate a data packet to include the first data and a first quality of service code, the first quality of service code assigned to provide the quality of service corresponding to the type of communications as specified by the notification; and
communicate the generated data packet over the secured tunnel, the secured tunnel forwarding the generated data packet in accordance with the first quality of service code.

24. The system as in claim 23, wherein the communication management hardware is further operable to:
at the wireless base station, retrieve the first data from the generated data packet; and
forward the first data over the wireless connectivity to the mobile communication device.

25. The system as in claim 14, wherein the communication management hardware is further operable to:
apply the first data flow control settings to a cable modem and a cable modem termination system in the network path to convey data associated with the communications in accordance with a quality of service assigned to the type of communications as specified by the notification.

26. The system as in claim 14, wherein the communication management hardware is further operable to:
apply the first data flow control settings to multiple routers in the network path to convey data associated with the communications in accordance with a quality of service assigned to the type of communications as specified by the notification.

27. Computer-readable storage hardware having instructions stored thereon, the instructions, when carried out by computer processor hardware, cause the computer processor hardware to:
receive a notification of a mobile communication device requesting to establish wireless connectivity with a wireless base station, the notification indicating a type of communications to be supported by the wireless connectivity;
in response to the notification, select first data flow control settings based on the indicated type of communications associated with the wireless connectivity; and
implement the first data flow control settings in a network path between the wireless base station and the remote network to support the type of communications indicated by the notification.
